(19) United States
(12) Patent Application Publication
(10) Pub. No.: US 2017/0076626 A1
(43) Pub. Date: Mar. 16, 2017

(54) System and Method for Dynamic Response to User Interaction

(71) Applicant: SeaShells Education Software, Inc., San Mateo, CA (US)

(72) Inventors: Melanie Jing Yee Lam, Pittsburgh, PA (US); Umang Gupta, San Mateo, CA (US); Gregory Aist, San Mateo, CA (US); Rodrigo Cano, Ft. Lauderdale, FL (US)

(21) Appl. No.: 14/853,054

(22) Filed: Sep. 14, 2015

(51) Int. Cl. G09B 17/00; G10L 15/04; G09B 5/06; G10L 15/22

(52) U.S. Cl. CPC G09B 17/006; G10L 15/22; G10L 15/04; G09B 5/06

(57) ABSTRACT

A computing device, having a user input interface including an input button, processes a sentence array including component words of a target sentence string to determine at least one target word to be read by the user. The computing device detects press and hold by the user of the input button, and in direct response, receives and processes user speech input to recognize at least one spoken word, and upon recognizing the at least one spoken word, determines whether the user has correctly read the at least one target word. The computing device also detects release by the user of the input button, and in direct response, identifies a context position relative to the target sentence string, and processes at least one predefined action based on the identified context position.

### FIELD OF THE INVENTION

This invention relates generally to speech recognition systems that provide dynamic response to user interaction, and more particularly to computer-assisted reading programs that provide dynamic assistance during the reading session.

### BACKGROUND

Systems for computer-assisted reading assistance based on speech recognition are generally known, in which voice recognition software listens to users reading displayed text aloud, monitoring for difficulties such as mispronunciation of a word, and providing assistance in response, such as offering the correct pronunciation of the word in question. Providing an effective and intuitive computer-assisted reading system is particularly difficult for a number of reasons. Speech recognition is very sensitive and a recognition engine may not reliably understand and process input speech of varying voice quality and pitch, especially in the presence of excess background noise preceding, during, and/or following the user utterances.

Well known speech recognition interfaces in other application contexts typically require the user to press a button, or utter a predefined key phrase, to start a speech capture session on a computer device, and subsequently require the user to press a button again to stop the speech capture session, or involves signal processing to detect when the user has stopped speaking. In such systems, the user interacts with the speech system to input a voice command or query utterance within the wider speech capture session, and the systems are thus prone to recognition issues from any background noise that is picked up by the microphone before and after the actual user utterance, as is evidenced by the number of errors one typically encounters with such systems today.

Moreover, such known speech session mechanisms are impractical for implementation in a reading assistance type of application, since the typical act of reading a text often requires word by word tracking of the speech input and dynamic feedback and response must be provided at any point in mid-sentence in order to enable quick and timely corrections and/or assistance to the reader. For example, waiting for an entire sentence to be read aloud by the user before the system processes the input speech to correct the reader and/or give feedback may cause the entire feedback to become incomprehensible or irrelevant due to the delay. Similarly, waiting to detect silence or a drop in the audio power signal may introduce an undesirable delay in providing reading assistance, whereas requiring the user to press a button once to turn the microphone on and again to turn the microphone off for speech input of each and every word is impractical for a typical reading assistant application and prone to interaction inaccuracy.

Another issue is what happens when a user encounters a system speech recognition error on a particular word or phrase. Since most speech recognition systems often have a high level of errors in accurately identifying speech input, the user may end up repeating a target word or phrase with increased frustration when faced with such “false rejection” type errors resulting in the later attempts at reading the remaining words in the sentence becoming increasingly inaccurate. Furthermore, capturing and processing input from the microphone unnecessarily may lead to increased battery drain, which is a particular issue for mobile computing devices that rely on a battery power source.

What is desired is a computer-assisted reading program that addresses the above issues.

### SUMMARY OF THE INVENTION

Aspects of the present invention are set out in the accompanying claims.

According to one aspect, the present invention provides a method for providing a dynamic response to user interaction, comprising, at a computing device with a user input interface including an input button, processing a sentence array including component words of a target sentence string to determine at least one target word to be read by the user, the determined at least one target word defining a context position relative to the target sentence string, detecting press and hold by the user of the input button, and in direct response to detecting the press and hold by the user of the input button: receiving user speech input, processing the user speech input to recognize in the user speech input at least one spoken word, and upon recognizing the at least one spoken word, determining whether the user has correctly read the at least one target word; and detecting release by the user of the input button, and in direct response to detecting the release by the user of the input button: identifying the context position relative to the target sentence string, and processing at least one predefined action based on the identified context position.

The target sentence string and an indication of the at least one target words to be read by the user may be output to a display of the computing device. The at least one predefined action may further comprise outputting audio, visual and/or tactile indication associated with the one or more target words to be read by the user. The at least one predefined action may comprise retrieving and outputting an audible representation of said target word. The audible representation may be retrieved from a database.

The at least one predefined action may further comprise processing the sentence array to determine a subsequent at least one target word to be read by the user. The at least one predefined action may further comprise sending a notification to a processing module of the computing device, such as a timer or game engine.

The computing device may be configured to detect a plurality of releases by the user of the input button while at the same context position, and in direct response to each subsequent release by the user of the input button, process a respective predefined action to output one of a series of escalating assistance.

The at least one predefined action may be further based on the user's age or experience level. At least one predefined action may comprise retrieving and outputting one of a set of audible representations of said target word, or an audible and/or visual version of at least one target word.

A match score may be calculated, associated with the determination of whether the user has correctly read the at least one target word, and the output indication may be based on the calculated match score.

A different action may be predefined for respective ones of a plurality of context positions. The context position may be defined relative to one of the start and end of the target sentence string. The context position may be defined relative to the end of the target sentence string is associated with a predefined action to retrieve a subsequent sentence array including component words of another target sentence string. The context position defined relative to the end of the target sentence string may be further associated with a predefined action to calculate and generate dynamic feedback based on the processing of user speech input to recognize the component words of the target sentence string.

The user input interface may be a touch screen display including a virtual button, and/or may include a peripheral device such as a mouse or trackball. Alternatively, the user input interface may include a physical button.

In another aspect, the present invention provides a system for providing a dynamic response to user interaction, comprising a user input interface including an input button, and one or more processors configured to detect press and hold by the user of the input button, and in direct response to detecting the press and hold by the user of the input button: receive user speech input, process the user speech input to recognize in the user speech input at least one spoken word, and determine based on the recognized at least one spoken word that the user has correctly read at least one target word of a target sentence string; and detect subsequent release by the user of the input button, and in direct response to detecting the release by the user of the input button: identify a context position relative to the target sentence string defined by the at least one target word, and process a predefined action based on the identified context position.

In a further aspect, there is provided a non-transitory computer-readable medium comprising computer-executable instructions, that when executed by a computing device perform the methods as described above.

### BRIEF DESCRIPTION OF THE DRAWINGS

There now follows, by way of example only, a detailed description of embodiments of the present invention, with references to the figures identified below.

FIG. 1 is a block diagram showing the main components of a user speech input processing system according to an embodiment of the invention.

FIG. 2 is a flow diagram illustrating the main processing steps performed by the system of FIG. 1 according to an embodiment.

FIG. 3 is a schematic illustration of an exemplary computing device configured to perform the method of FIG. 2.

FIG. 4 is a flow diagram illustrating exemplary processing steps to provide context-sensitive computer-assistance according to an embodiment.

FIG. 5 is a diagram of an example of a computer system on which one or more of the functions of the embodiments may be implemented.

### DETAILED DESCRIPTION

### Overview

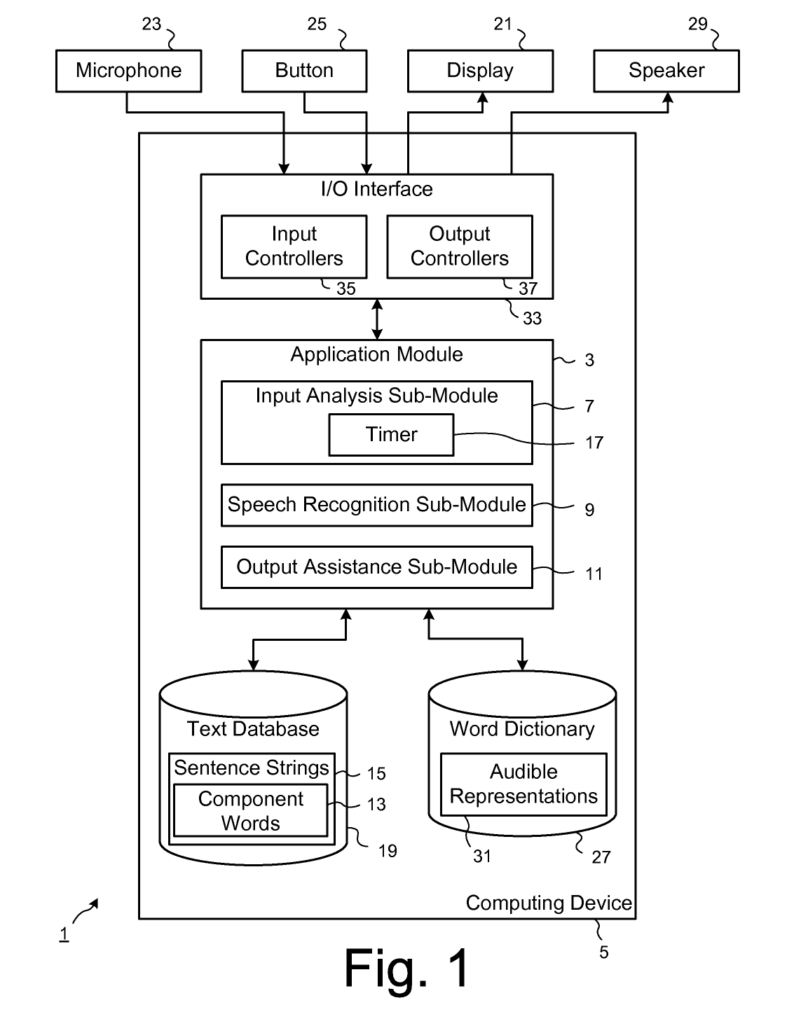

A specific embodiment of the invention will now be described for a system and method of processing user speech input to track progress as a user reads aloud component words of a target sentence string, and responding dynamically based on user interaction with a computing device. Referring to FIG. 1, a system 1 for processing speech input from the user includes an application module 3 configured to be executed on a computing device 5. In this embodiment, the application module 3 includes an input analysis sub-module 7, a speech recognition sub-module 9, and an output assistance sub-module 11, which interact to determine whether the user has correctly read component words 13 of a received target sentence string 15 or if computer-assistance is to be provided at a particular location of the target sentence string, as will be described in more detail below. The input analysis sub-module 7 may include a timer 17 to measure a predetermined time interval within which one or more target words of the target sentence string is to be recognized.

The application module 3 may be an educational computer game program for teaching a user to read/count/sing, an educational computer program for teaching a user a second language, an entertainment computer program for karaoke or interactive jokes and riddles, an instructional computer program providing an interactive instruction/repair manual or assisting an actor with memorization of their respective portions of dialog, or other computer software that integrates reading detection and context-sensitive computer-assistance. The application module 3 may retrieve the target sentence string 15, for example from a text database 19. The application module 3 may instead or additionally be configured to generate target sentence strings including a plurality of component words. It will be appreciated that each target sentence string may be a complete sentence, a plurality of sentences (for example a page of text), and/or an incomplete sentence or phrase, and may be grammatically correct or incorrect. A plurality of target sentence strings may be linked in sequence to form a selectable text corpus, such as a story, joke, song, play, poem, instruction manual, etc.

The application module 3 may generate and output a text of the target sentence string 15 to be displayed on a display 21 for viewing by the user. The application module 3 may also generate and output a prompt to the user to read aloud one or more target words 13 of the target sentence string 15, for example by indicating or highlighting the one or more target words 13 on the display 21. The user may attempt to read the text and generate a user speech input via a user input device, such as a microphone 23, which is associated with the computing device 14 and is configured to transmit the user speech input to the application module 3.

The input analysis sub-module 7 is configured to detect and respond to interaction by the user with a predefined input button 25. In this embodiment, the input analysis sub-module 7 detects press and hold by the user of the input button 25, and in direct response, sends a notification or instruction to the speech processing sub-module 9 to begin receiving and processing user speech input. The speech recognition sub-module 9 is configured to receive the user speech input from the microphone 23, and process the received user speech input to recognize one or more spoken words in the user speech input. It will be appreciated that the speech recognition sub-module 9 may be of a type that is known per se, and need not be described further. The input analysis sub-module 7 may receive a notification from the speech recognition sub-module 9 identifying the recognized one or more spoken words. Upon receiving the recognized one or more spoken words from the speech recognition sub-module 9, the input analysis sub-module 7 determines whether the user has correctly read the at least one target word.

The input analysis sub-module 7 is also configured to detect the subsequent release by the user of the input button, and in direct response, send a notification to the output assistance module 11 to perform one or more predefined context-sensitive actions, based on an identified context position relative to the target sentence string at the time the input button 25 was released by the user. The input analysis sub-module 7 may be configured to identify the context position from the one or more target words that the user was prompted to read aloud at the time the input button 25 was released. The predefined context-sensitive actions may include one or more of:
outputting an audible representation 27 of the one or more target words to a speaker 29,
displaying a visual indication such as highlighting or a textual/graphical hint relative to the context position within the target sentence string,
outputting audiovisual assistance such as a video of an expert performing an associated task,
calculating and outputting feedback on reading accuracy at the end of a target sentence string,
retrieving the next target sentence string after the user has reading or attempted to read the final word in the current target sentence string,
outputting a modified audio or visual background based on the identified context-position, and
providing tactile feedback such as operation of a vibration device.

The vibration device may be configured to provide tactile feedback at different amplitudes based on a determination of how close the user's speech input matches the one or more target words. Audible representations 31 of the component words 13 may be stored in a word dictionary database 27. It will be appreciated that the word dictionary database 31 may be provided on and/or loaded to a memory of the computing device 5 from removable computer-readable media, or retrieved from a remote server via a data network (not shown).

The computing device 5 includes an I/O interface 33 that couples input/output devices or peripherals of the computing device 5, such as the display 21, microphone 23, one or more physical buttons 25, such as push buttons, rocker buttons, etc., speaker 29, and other input/control devices (not illustrated), to the application module 3. The I/O subsystem 33 includes a plurality of input controllers 35 and output controllers 37 to receive/send electrical signals from/to the respective input/output devices or peripherals. It will be appreciated that the display 21, microphone 23, button(s) 25, and speaker 29 may be integral devices/components of the computing device 5, coupled to the application module 3 via the I/O interface 33. In an embodiment, the display 21 is a touch screen having a touch-sensitive surface to provide both an input interface and an output display interface between the computing device 5 and the user. In such an embodiment, the touch screen may display visual output to the user, the visual output including a graphical element corresponding to a user-interface object to implement a virtual or soft button 25.

In this way, the present embodiment provides a single button input mechanism that allows for the user not only to establish the start of an input speech segment, but also to efficiently and seamlessly seek context-sensitive prompts, answers, confirmation, or other kind of system generated feedback or assistance, and after receiving the context-sensitive computer-assistance, to return seamlessly back to speech input. With the press-hold-release mechanism of the present embodiments, the system provides an efficient context-sensitive dynamic response at any point within a read-aloud sentence, which enables users to quickly and easily recover from a situation when they do encounter a speech recognition error, so that they can be prompted for the correct word/phrase, and continue seamlessly with the rest of the sentence without missing a beat.

### Dynamic Computer-Assistance Process

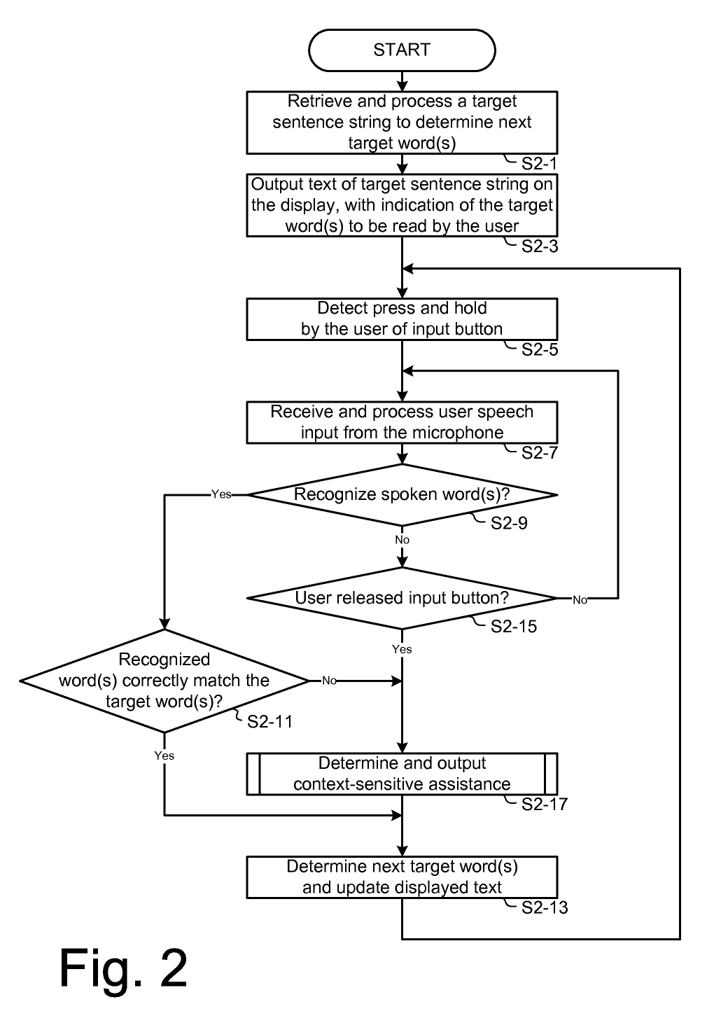

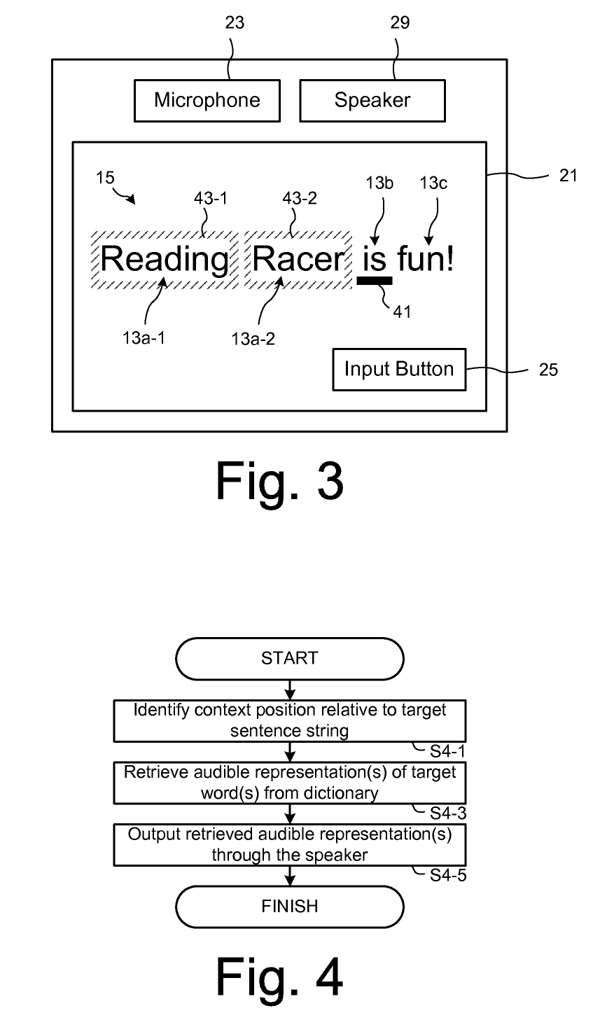

A description has been given above of the components forming part of the speech input processing system 1 of an embodiment. A more detailed description of the operation of these components will now be given with reference to the flow diagrams of FIG. 2, for an example computer-implemented process according to an embodiment. Reference is also made to FIG. 3, schematically illustrating an exemplary computing device configured to perform the speech input and dynamic computer-assistance process according to this embodiment.

As shown in FIG. 2, the process begins at step S2-1 where the input analysis sub-module 7 of the application module 3 retrieves a target sentence string 15, for example from the text database 19. The input analysis sub-module 7 processes the retrieved target sentence string 15 to determine the next target word (or words) 13 that is to be read aloud by the user, this being the first word in the retrieved target sentence string the first time the process is executed. Referring to the example illustrated in FIG. 3, the application module 3 may be configured to output the target sentence string 15 as one or more graphical elements on the display 21, and to display a prompt or indication 41 for the user to read aloud each component word 13 of the target sentence string 15 individually and in turn. In this embodiment, a single virtual or soft input button 25 is displayed on the display 21, and the user uses the single input button 25 to interact seamlessly with the application module 3. As the application module 3 determines that each component word 13a is read correctly by the user, the graphical elements for the correct recognized words 13a may be modified with respective highlights 43, and the prompt 41 moved to the next target word 13b of the target sentence string 15. It will be appreciated that the application module 3 may be configured to prompt the user to record user speech input of a plurality of component words 13 of the target sentence string 15, and to process user speech input to recognize a corresponding plurality of spoken words.

Accordingly, at step S2-3, the input analysis sub-module 7 generates and outputs a text of the target sentence string 15 on the display 21, together with an indication of the next target word 13b to be read by the user. At step S2-5, the input analysis sub-module 7 detects that the user has pressed and is holding the input button 25. For example, the application module 3 may receive a user input event notification from the I/O interface 33 (or the operating system of the computing device 5). In direct response to detecting the press and hold by the user of the input button 25, the input analysis sub-module 7 sends a notification or instruction to the speech processing sub-module 9 to begin capturing or recording user speech input from the microphone 23. At step S2-7, the speech processing sub-module 9 receives user speech input from the microphone 23, and processes the received user speech input to recognize a spoken word. If the speech processing sub-module 9 determines at step S2-9 that a spoken word is recognized, then a notification with the recognized word is sent to the input analysis sub-module 7, which makes a determination at step S2-11 if the recognized word correctly matches the target word 13b.

If the input analysis sub-module 7 determines that the recognized word correctly matches the target word 13b, then at step S2-13, the input analysis sub-module 7 determines the next target word 13c from the target sentence string 15 that is to be read by the user. The input analysis sub-module 7 may also update the displayed text to highlight 43 the correctly matched word(s), and to move the prompt 41 to the next target word 13c to be read by the user. Processing then returns to step S2-5 for the next target word.

Referring back to step S2-9, if on the other hand the speech processing sub-module 9 has not yet recognized a spoken word, and it is determined at step S2-15 that the input analysis sub-module 7 has not detected release by the user of the input button 25, then processing returns to step S2-7 where the speech processing sub-module 9 continues to receive user speech input from the microphone 23, and process the received user speech input to recognize a spoken word. On the other hand, when the input analysis sub-module 7 detects at step S2-15 that the user has released the input button 25, for example on receiving a user input event notification from the I/O interface 33 (or operating system of the computing device 5), then at step S2-17, the input analysis sub-module 7 may send a notification to the output assistance module 11 to perform one or more predefined actions to provide dynamic computer-assistance to the user. As will be described in more detail below, the output assistance module 11 responds directly by determining and outputting context-sensitive assistance based on an identified context position relative to the target sentence string at the time the input button 25 was released by the user, such as outputting the correct pronunciation of the target word to the speaker 29. Processing then continues to step S2-13 where the input analysis sub-module 7 determines and processes the next target word, as described above.

In an alternative embodiment, the input analysis sub-module 7 may instead prompt the user to re-attempt to read aloud the same target word 13b, where the user should be able to correctly or more accurately pronounce the target word 13b after receiving the context-sensitive assistance. Additionally, it will be appreciated that although step S2-15 is illustrated as a separate and subsequent step to step S2-9, the input analysis sub-module 7 is preferably configured to respond directly once release by the user of the input button 25 is detected. In this way, the application module 3 may be configured to continually receive and process user speech input while the user is holding the input button 25, and to respond immediately once the user has released the input button 25.

FIG. 4 is a flow diagram of an exemplary sub-process to determine and output context-sensitive assistance in the present embodiment. As shown in FIG. 4, at step S4-1, the output assistance module 11 is configured to respond to the notification from the input analysis sub-module 7 by identifying a context position relative to the target sentence string 15. In this simplified exemplary embodiment, the context position is identified as the start or middle of the target sentence string 15, based on the current target word 13 that the user is attempting to read aloud. In response, the output assistance module 11 of the application module 3 is configured to output an audible representation of the current target word 13b to the speaker 29 as a predefined context-sensitive action, thus teaching the user the correct pronunciation of the target word 13b. Accordingly, at step S4-3, the output assistance module 11 retrieves an audible representation 31 of the current target word, and outputs the retrieved audible representation 31 through the speaker 29 at step S4-5. It will be appreciated that in an alternative embodiment, the application module 3 may be configured to generate and output a synthesized audible representation of the target word 15. The output assistance module 11 may be further configured to send a notification or instruction to the timer # and/or another processing module such as a computer game engine, as an additional predefined context-sensitive action, for example to pause the timer and/or an action of the game.

The output assistance module 11 may be further configured to identify the context position as the end of the target sentence string 15, for example after the user has read aloud all of the component words 13 of that target sentence string 15. In response, the output assistance module 11 may be configured to calculate and generate dynamic feedback based on the processing of user speech input to recognize each of the component words 13 of the target sentence string 15, before the input analysis sub-module 7 proceeds to retrieve the next sentence string 15 for processing from step S2-1 as described above. In another exemplary embodiment, a different action may be predefined for respective ones of a plurality of context positions.

It will be appreciated that numerous alternative forms of context-sensitive assistance are envisaged, in response to detection by the application module 3 of the release by the user of the input button 25. Purely by way of exemplary implementations, in an educational computer program for teaching a user a second language, the user may press and hold the button to read aloud a displayed question, and the computer-assistance on detected release of the button may include the appropriate response to the read-aloud question in the chosen language. In an entertainment computer program for karaoke, the user may press and hold the button to sing a displayed line of a song, and the computer-assistance on detected release of the button may include audible output of the line in song, or remainder of the line, sung out in perfect pitch. In an entertainment computer program for interactive jokes and riddles, the user may press and hold the button to read aloud a displayed portion of the joke or the riddle, and the computer-assistance on detected release of the button may include output of the final punch line of the read-aloud joke or the answer to the read-aloud riddle. In an instructional computer program providing an interactive instruction/repair manual, the user may press and hold the button to read aloud a displayed step of a repair process, and the computer-assistance on detected release of the button may include output of the appropriate tool to use or the machine part to employ in the read-aloud step of the repair process. In an instructional computer program enabling actors to memorize their dialog in a play, or a person to memorize their speech, or rehearse for a poetry read-aloud session, the user may press and hold the button to read aloud their portions of dialog, and the computer-assistance on detected release of the button may include audible output of the other actors' lines and/or providing a prompt/hint to help the user remember their own next line.

### Computer Systems

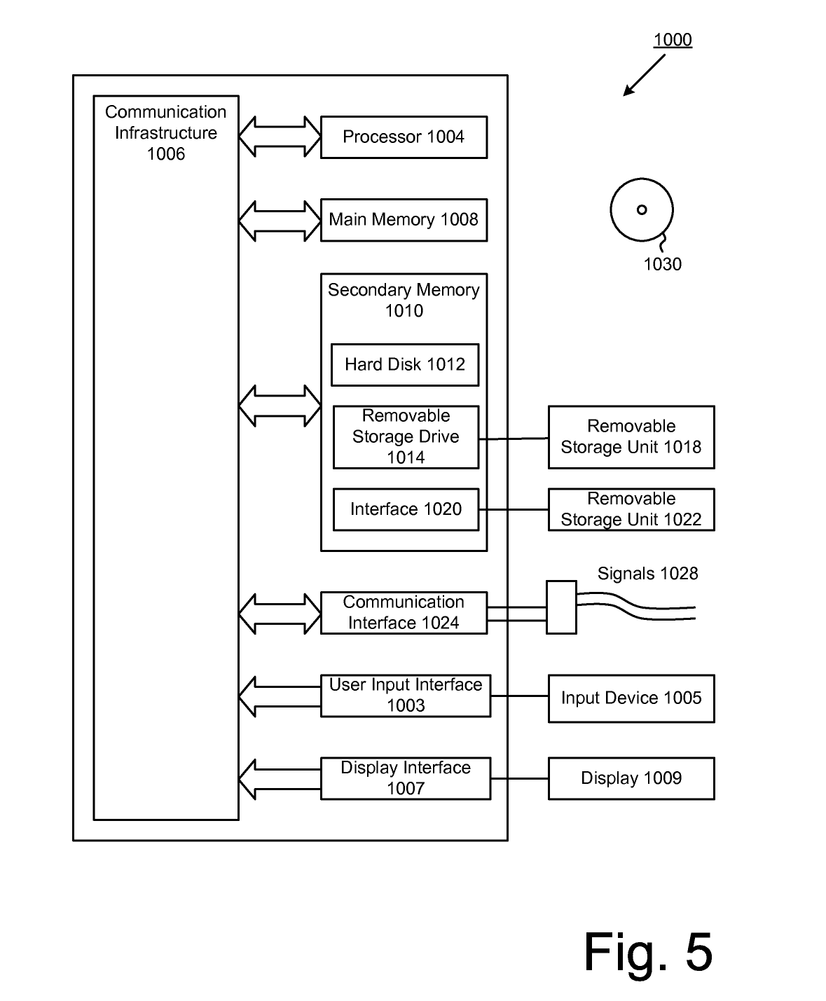

The computing device described herein may be implemented by computer systems such as computer system 1000 as shown in FIG. 5. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof

### Further Alternative Embodiments

It will be understood that embodiments of the present invention are described herein by way of example only, and that various changes and modifications may be made without departing from the scope of the invention.

For example, in the embodiments described above, the application module includes a speech recognition sub-module configured to receive the user speech input from the microphone, and process the received user speech input to recognize one or more spoken words in the user speech input. As those skilled in the art will appreciate, the speech recognition sub-module may be configured to receive the one or more target words from the input analysis sub-module, and upon recognizing the at least one spoken word, determine whether the user has correctly read the at least one target word. The speech processing sub-module may be further configured to calculate a match score associated with the determination, for example as a measure of accuracy indicating how close the user's speech input and/or the recognized spoken word(s) is/are to the one or more target words.

As a further modification, the speech recognition sub-module may be configured to perform processing of user speech input based on the user's age and/or reading ability/level. For example, the speech recognition sub-module may use one of a plurality of dictionaries each adapted to a respective reader developmental stage. In one such dictionary adapted for a younger reader, words such as ‘RUN’ could be associated with an alternate pronunciation ‘WUN’ to reflect that children may develop the /r/ sound later than other phonemes. In this way, the speech recognition sub-module is configured to correctly match user speech input to the component words, taking into account expected pronunciation errors for a reader's developmental stage.

As another alternative, the speech recognition sub-module and/or the input analysis sub-module may instead be provided as one or more distributed computing modules or processing services on a remote server that is in communication with the computing device via a data network. Additionally, as those skilled in the art will appreciate, the application module may be provided as an application programming interface (API) accessible by another application program, or as a plug-in module, extension, embedded code, etc., configured to communicate with another application program.

In the embodiments described above, the application module is configured to determine and output context-sensitive assistance in response to detection that the user has released the input button, or determination that the user has incorrectly uttered the target word. As those skilled in the art will appreciate, the input analysis sub-module may be further configured to implement a timer measuring a predetermined time interval within which the current target word is to be recognized has expired. If the input analysis sub-module determines that the timer has expired, then a notification may be sent to the output assistance module to process the one or more predefined actions to provide computer-assistance to the user, for example as discussed above.

In the embodiments described above, the application module is configured to determine and output context-sensitive assistance based on an identified context position relative to the target sentence string. As those skilled in the art will appreciate, the output assistance module may be configured to determine and output context-sensitive assistance further based on the user's age or experience level. As yet another modification, the press-hold-release user input mechanism described in the embodiments above may be further configured to support several modes of interaction. For example, in a first mode, the user can press and hold the button down, and speak an entire attempt of the target word or words, releasing the button only at the end of the utterances, whereby computer-assistance by the output assistance sub-module may consist of feedback on the completed attempt. In a second mode, the user may press and hold the button down, speak part of an attempt, release the button to receive assistance for the remainder of the sentence, and then press and hold again to complete the attempt. In a third mode, the user may press and release the button several times in succession in order to receive a series of computer-assistance, such as escalating hints. In this third mode, the application module may detect the plurality of releases by the user of the input button while at the same context position, and in direct response to each subsequent release by the user of the input button, process a respective predefined action to output one of a series of escalating assistance.

For example, different versions of the audible representation may be stored for each component word, where one version provides a short hint to the correct pronunciation of the word, such as an initial phoneme, another version provides a longer hint, such as two or more phonemes, and a final version may provide a correct pronunciation of the complete word. Similarly, different versions of visual hints may be output by the output assistance module, depending on the identified context position as well as the user's age or experience level.

Yet further alternative embodiments may be envisaged, which nevertheless fall within the scope of the following claims.

1. A method for providing a dynamic response to user interaction, comprising:
at a computing device with a user input interface including an input button:
processing a sentence array including component words of a target sentence string to determine at least one target word to be read by the user, the determined at least one target word defining a context position relative to the target sentence string;
detecting press and hold by the user of the input button, and in direct response to detecting the press and hold by the user of the input button:
receiving user speech input;
processing the user speech input to recognize in the user speech input at least one spoken word; and
upon recognizing the at least one spoken word, determining whether the user has correctly read the at least one target word; and
detecting release by the user of the input button, and in direct response to detecting the release by the user of the input button:
identifying the context position relative to the target sentence string; and
processing at least one predefined action based on the identified context position.

2. The method of claim 1, further comprising outputting, to a display of the computing device, the target sentence string and an indication of the at least one target words to be read by the user.

3. The method of claim 2, wherein the at least one predefined action further comprises outputting audio, visual and/or tactile indication associated with the one or more target words to be read by the user.

4. The method of claim 3, wherein the at least one predefined action comprises retrieving and outputting an audible representation of said target word.

5. The method of claim 4, wherein the audible representation is retrieved from a database.

6. The method of claim 3, wherein the at least one predefined action further comprises processing the sentence array to determine a subsequent at least one target word to be read by the user.

7. The method of claim 3, wherein the at least one predefined action further comprises sending a notification to a processing module of the computing device.

8. The method of claim 1, further comprising detecting a plurality of releases by the user of the input button while at the same context position, and in direct response to each subsequent release by the user of the input button, processing a respective predefined action to output one of a series of escalating assistance.

9. The method of claim 1, wherein the at least one predefined action is further based on the user's age or experience level.

10. The method of claim 8 or 9, wherein at least one predefined action comprises retrieving and outputting one of a set of audible representations of said target word.

11. The method of claim 8 or 9, wherein at least one predefined action comprises retrieving and outputting an audible and/or visual version of at least one target word.

12. The method of claim 3, wherein determining whether the user has correctly read the at least one target word includes calculating a match score associated with the determination, and wherein the output indication is based on the calculated match score.

13. The method of claim 1, wherein a different action is predefined for respective ones of a plurality of context positions.

14. The method of claim 1, wherein the context position is defined relative to one of the start and end of the target sentence string.

15. The method of claim 14, wherein the context position defined relative to the end of the target sentence string is associated with a predefined action to retrieve a subsequent sentence array including component words of another target sentence string.

16. The method of claim 14, wherein the context position defined relative to the end of the target sentence string is further associated with a predefined action to calculate and generate dynamic feedback based on the processing of user speech input to recognize the component words of the target sentence string.

17. The method of claim 1, wherein the user input interface is a touch screen display.

18. A system for providing a dynamic response to user interaction, comprising:
a user input interface including an input button;
one or more processors configured to:
detect press and hold by the user of the input button, and in direct response to detecting the press and hold by the user of the input button: receive user speech input, process the user speech input to recognize in the user speech input at least one spoken word, and determine based on the recognized at least one spoken word that the user has correctly read at least one target word of a target sentence string; and
detect subsequent release by the user of the input button, and in direct response to detecting the release by the user of the input button: identify a context position relative to the target sentence string defined by the at least one target word, and process a predefined action based on the identified context position.

19. A non-transitory computer-readable medium comprising computer-executable instructions, that when executed by a computing device perform the method of:
receiving a sentence array including component words of a target sentence string;
processing the sentence array to determine at least one target word to be read by the user, defining a context position relative to the target sentence string;
detecting press and hold by the user of the input button, and in direct response to detecting the press and hold by the user of the input button:
receiving user speech input;
processing the user speech input to recognize in the user speech input at least one spoken word; and
upon recognizing the at least one spoken word, determining whether the user has correctly read the at least one target word; and
detecting release by the user of the input button, and in direct response to detecting the release by the user of the input button:
identifying the context position relative to the target sentence string; and
processing at least one predefined action based on the identified context position.
